(19) United States
(12) Patent Application Publication
(10) Pub. No.: US 2025/0308403 A1
(43) Pub. Date: Oct. 2, 2025

(54) SAFE-DRIVING TRAINING SYSTEM AND METHOD

(71) Applicant: INNOCORP, LTD., VERONA, WI (US)

(72) Inventors: Patrick M. Collins, VERONA, WI (US); Timothy Jorgensen, VERONA, WI (US); Debra C. Kusmec-Aguilar, VERONA, WI (US); Lisa M. Koehler, VERONA, WI (US)

(21) Appl. No.: 19/096,485

(22) Filed: Mar. 31, 2025

Related U.S. Application Data
(60) Provisional application No. 63/572,641, filed on Apr. 1, 2024.

(51) Int. Cl. G09B 9/05

(52) U.S. Cl. CPC G09B 9/05

(57) ABSTRACT

System and methodology recreating, in an exercise, an environment where a person-participant drives in a reckless manner through oncoming obstacles at varying speeds and configured to train a driver to reduce errors while on the road. The system includes a tangible safe-driving course, sensors recognizing inputs providing to the course by the participant; and processor programmed to modify the operation of the source in response to outputs from sensors. The participant is challenged to make decision by steering and stopping when prompted at the electronic device of the course. When the decision is incorrect or a stimulus is missed, the system respond by at least crashing noise(s) and flashing of light and records the mistake. The results are presented on the same electronic device in graphic form.

### CROSS-REFERENCE TO RELATED APPLICATIONS

This international patent application claims priority from and benefit of the U.S. provisional patent application No. 63/572,641 filed on Apr. 1, 2024, the disclosure of which is incorporated herein by reference.

### TECHNICAL FIELD

The present disclosure relates to systems and methods for training human beings to drive safely.

### RELATED ART

Reckless driving remains a major health concern amongst multiple populations. There is a great need to identify better safe-driving training methodologies and protocols that are simple enough to be performed at home and that lead to factual reductions in errors motorists make when on the roads.

Existing training protocols typically focus on the use of visual, proprioceptive, or vestibular perturbations. Visual perturbations may be the easiest to enact without complicated equipment and vision is especially important when driving on an unfamiliar road or terrain. walking on a narrow surface or acquiring a new motor skill. To this end, virtual reality headsets, while providing versatile set of exercises, remain bulky, expensive, and often induce motion sickness.

A need exists for a safe-driving protocol that can be implemented at home without the need for virtual reality headsets and at relatively low cost and that is very effective.

### SUMMARY

Embodiments of the invention provide a system for training safe driving by a human subject. Such system includes a human safe-driving course to be performed by the human subject during at least one driving training session and first and second sensors configured to detect inputs applied to the course by the human subject during the at least one driving training session and to generate output signals representing said inputs. The system additionally includes a processor operably coupled with a tangible non-transitory memory storage and configured at least to execute a driving training program code stored in such storage. The driving training program code includes at least (i) code for processing the output signals to record first data representing tangible responses of the human subject to changes in the human safe-driving course during the at least one driving training session, (ii) code for modifying operation of the human safe-driving course in response to the output signals, and (iii) code for recording second data representing the operation of the human safe-driving course in correspondence to the output signals. Optionally, the system may additionally include a device configured to impede vision of the human subject when placed in a line of sight of the human subject. Such device may be (a) a pair of occlusion glasses to be worn by the human subject during the at least one driving training session (here, the pair of occlusion glasses may include a pattern at least partially obscuring a peripheral region of an optical filter of the pair of occlusion glasses and/or a plurality of independently electronically-controllable regions of the optical filter that are structure to change opacity thereof), or (b) a pair of goggles to be worn by the human subject during at least one driving training session (here, the pair of goggles may contain first and second optical filter elements and a first axis connecting centers of the first and second optical filter elements and a second axis that is substantially perpendicular to the first axis, and at least one of said first and second optical filter elements includes a pattern in a body thereof, the pattern (i) defining different phase delays for first and second collimated light beams that are incident on said at least one of the first and second optical filter elements substantially normally to a plane defined by the first and second axes and (ii) extending substantially straight along a third axis in the plane, the third axis being either inclined with respect to the first axis or substantially parallel to the first axis).

Embodiments additionally provide a method that includes performing at least the following steps with the use of substantially every implementation of the system disclosed in this application: a step of during a first driving training session and with the use of a processor, executing program code to introduce changes in the human safe-driving course by varying first visually-perceivable indicia in a first fashion (here, the first visually-perceivable indicia represent at least a road and/or change in road conditions in time and are generated by a constituent device of the human safe-driving course; the step of generating first output signals representing tangible responses of the human subject to such changes with the first and second sensors; the step of repositioning second visually-perceivable indicia representing the human subject across a surface of the constituent device in response to said first output signals; and the step of recording first output data representing the tangible responses and second output data representing operation of the human safe-driving course in correspondence to the first output signals during the first driving training session. In at least one implementation, the method may include—alternatively or in addition—at least one of the following steps performed with the use of the processor: (a) when only the first driving training session has been completed, comparing the first output data and second output data to produce indicia characterizing the tangible responses during the first driving training session; and (b) when more than one driving training session has been completed, at least comparing the second output data and auxiliary output data representing operation of the human safe-driving course in correspondence to output signals produced by the first and second sensors during an auxiliary driving training session completed in addition to the first driving training session to produce indicia characterizing changes in said tangible responses between the first driving training session and the auxiliary driving training session. Optionally, the method may incorporate unfolding or unrolling a constituent electronic device of the human safe-driving course to position an array of sources of light affixed to a flexible mat of constituent device to face the human subject.

### BRIEF DESCRIPTION OF THE DRAWINGS

The idea pf the invention will be more fully understood by referring to the following Detailed Description in conjunction with the generally not-to scale Drawings, of which:

FIG. 1 is a block diagram of a data processing unit of the system in accordance with a representative embodiment that contains a data processing unit for recording and assessing balance training performance.

FIGS. 2A, 2B, 2C, and 2D provide complementary illustrations of the structure and principle of operation of the discussed system.

FIGS. 3A, 3B, 3C, and 3D illustrate, with the use of indicia formed at the electronic device of the system of the invention, several different scenarios according to which the user terminates the operation of the human safe-riving course of the system.

FIGS. 4A, 4B present the output displayed at the electronic device of the system to present the summary of parameters characterizing the performance of the user during driving training session(s) undertaken with the use of the system of the invention.

FIG. 5 is a schematic representing an embodiment of the method of the invention.

FIG. 6 is a flow diagram representing a related embodiment of the method of the invention.

Generally, the sizes and relative scales of elements in Drawings may be set to be different from actual ones to appropriately facilitate simplicity, clarity, and understanding of the Drawings. For the same reason, not all elements present in one Drawing may necessarily be shown in another.

### DETAILED DESCRIPTION

The discussed below embodiments of the proposed methodology provide participants/users (and optionally participating instructors) with a tangible training platform configured to implement a safe-driving training protocol that reduces user's errors while on the road. Below, the terms “human subject” and “user” are used interchangeably. Embodiments of such methodology recreate an environment forcing the human subject that uses the training platform to participate in simulated reckless driving—for example, too fast. Data representing the results of the exercise, collected and then presented to the user (and the optional instructor) are then summarized and discussed to highlight the adverse outcomes caused by unsafe driving behavior.

To this end, the system around which the training platform is structured includes a human safe-driving course. This term, as used herein, describes a collection or kit of equipment configured to be used by a human user (human subject) to perform a variety of actions or exercises resembling at least controlling a vehicle's movement with the use of a proxy under circumstances that do not involve operating a vehicle, use of a road, and/or traffic attributes or situations, that do not mimic or resemble a driving simulation videogame (such as, for example, Car Driving School Simulator, Real Driving Simulator, Dr. Driving, and Virtual Driving School) and that are devoid of (that is, do not employ) a virtual or mixed reality device such as a head-mounted headset configured to create a simulated environment that feels real. Such actions of exercises are grouped into what is referred to as driving training sessions—that is, independent from one another periods of use of the human safe-driving course that generally differ from one another in at least one operational characteristic of the course. Put differently, a driving training session is an occurrence of using the human safe-driving course by the user.

Optionally, the use and interaction with the human safe-driving course can be carried out, besides the human user, an instructor for assessing and/or presenting and/or discussing with the user the results of the completion of the course. The instructor may be a live person and/or, optionally, the functions of the instructor may be implemented with the use of a programmable processor (such as a computer processor).

Unless expressly defined otherwise, the term proxy as used herein generally refers to a placeholder programming object, the function of which is to delegate the execution of an action to one or more other objects it controls access to, thereby allowing the placeholder to carry out other processing before and after that action. The term mock apparatus (such as a mock vehicle, for example) as used herein refers to an optical representation of a real version of such apparatus, and used for training, testing, or demonstration purposes, where the functionality is mimicked without the full complexity or potential risks of using the actual apparatus; essentially, it is visually-perceived practice model allowing users to learn procedures or test design concepts in a controlled environment. The term turn switch refers to and is defined as a generalized switch configured to operate something when twisted or turned, essentially any knob or wheel (such as a steering wheel, for example) that requires a rotational movement to function. Road signs are signs that provide information to drivers about traffic flow, hazards, and directions, and include regulatory signs, pedestrian signs, yield signs, and speed signs, to name just a few—in context of the embodiment(s) of the invention, as described.

One specific implementation of the human safe-driving course includes an electronic device configured to present visually at least information or data representing tangible responses of the human subject (or user) to changes of operational parameters of the human safe-driving course during a particular driving training session. Generally, such electronic device includes a substrate of an appropriate material carrying the static markings representing a road and peripheral areas around the road as well as a plurality of independently operable sources of light that are removably affixed to and/or at the substrate and which, in operation, form at least a first visually-perceivable representation of a road, a second visually-perceivable representation of a mock vehicle on the road, and a change of a third visually-perceivable representation of road conditions in time. While generally such electronic device may include a conventional display or monitor, in a preferred case the chosen substrate is a flexible mat with an (optionally removable from the mat) array of lights (such as light-emitting diodes or LEDs) affixed to the mat that recreate a driving scene from the top down, towards the user who visually perceives the changing road conditions in time while attempting to navigate a visual approximation of the user's car (with the contours outlines by such lights) through oncoming obstacles. The human safe-driving course is complemented with a processor/electronic circuitry configured to run the safe-driving training algorithm.

The discussed system is configured to recreate common driving scenarios for a human subject by using a multiplicity of LED lights, which is used to animate a road with continually changing conditions (For example, a group of cars in the right or left lanes). On this road, a human subject navigates a proxy vehicle through descending indicia, representing other cars, road obstacles, or places to stop. On the lateral edges of the road there may be dedicated additional sets of LEDs that run the length of the road; when illuminated, these lights create stimuli in the peripheral vision of the human subject. These peripheral stimuli replicate the perception of peripheral items in genuine driving experiences (For example, trees, bushes, buildings, exits, etc.). This creates a sense of speed and motion for the human subject. The hardware is able to condense down quickly and be deployed quickly for storage and use.

Pursuing the task of “avoiding a road collision” on the road optically represented at the electronic device, the user is challenged to make decisions by repositioning and/or changing an orientation of the optical representation of the user's vehicle between or among the visually presented obstacles by steering with the use of a turn switch and stopping with a brake pedal, when prompted. The input(s) applied to the human safe-driving course by the user via any or every of the turn switch and the brake pedal (which are operably connected with the electronic device—whether via an electrically-conducting member such as a wire or wirelessly) are recognized by respectively-corresponding sensors such as capacitive sensors, for example, that produce respective output signals representing such inputs. The programmable electronic circuitry—for example, a processor—that is preferably embedded into the mat or substrate to form a self-contained system (which is not employing a separate computer) (i) acquires such output signals to record first data representing tangible responses of the user to changes in the human safe-driving course during the at least one driving training session and/or (ii) modifies the operation of the human safe-driving course in response to such output signals (for example, changes the speed at which the visually-perceivable representations of other cars of the road simulated by the course are approaching the visually-perceivable representation of the user's car on the same road), and/or (iii) records corresponding data representing the operation of the human safe-driving course in relation to the output signals. Notably, as will be described below in more detail, changes in the human safe-driving course do not involve any changes to hardware comprising such course but, instead, manifest in changes of visual information presented to the user at the electronic device.

At least one of the task pursued by the user during a given training session is to keep repositioning a driver visual element (the indicia that is representing the vehicle of the user) to avoid a spatial overlap, as optically presented by the electronic device, between such driver visual element and at least one other visual element of the course—that is, to avoid a situation interpreted by the processor as a road collision.

At least in one case, the safe-driving training algorithm expressed in a program code run by the processor is configured to stop or suspend a given driving training session and/or produce a crashing sound and/or flashing light when the makes an incorrect decision and misses the obstacle (which may manifest in positioning the optical representation of the users vehicle at the location of the obstacle), the system responds with crashing noises, flashing, and records both the output signals from the sensors and corresponding operational parameters of the safe-driving course corresponding to the incorrect decision. Notably, to stimulate the practical circumstances where the vehicle on the road does not stop immediately following the application of brakes, the program code is configured to delay, in a pre-determined fashion, the repositioning and/or re-orientation of the optical representation of the user's vehicle at the electronic device after the user applies the input(s) to the turn switch and/or brake pedal.

### General System Structure.

In its basic configuration, the overall system for training safe driving includes a human safe-driving course, a processor operably coupled with a tangible non-transitory memory storage and configured at least to execute a driving training program code (which is stored in such storage and which implements the generally reconfigurable safe-driving training algorithm hereby producing a change of visually-perceived indicia at the human safe-driving course), and specifically dedicated sensors that are electrically connected with the processor and that are configured to detect input(s) applied to the course by the human subject during at least one run of the safe-driving training algorithm (a driving training session) and to generate output signals representing such inputs that affect which change of the visually-perceived indicia at the human safe-driving course is implemented. Accordingly, the constituent program codes of the driving training program code are at least those for processing the signals representing tangible responses of the human subject to changes in the human safe-driving course, for modifying the operation of the human safe-driving course in response to such output signals, and for recording data representing the operation of the human safe-driving course in correspondence to the output signals.

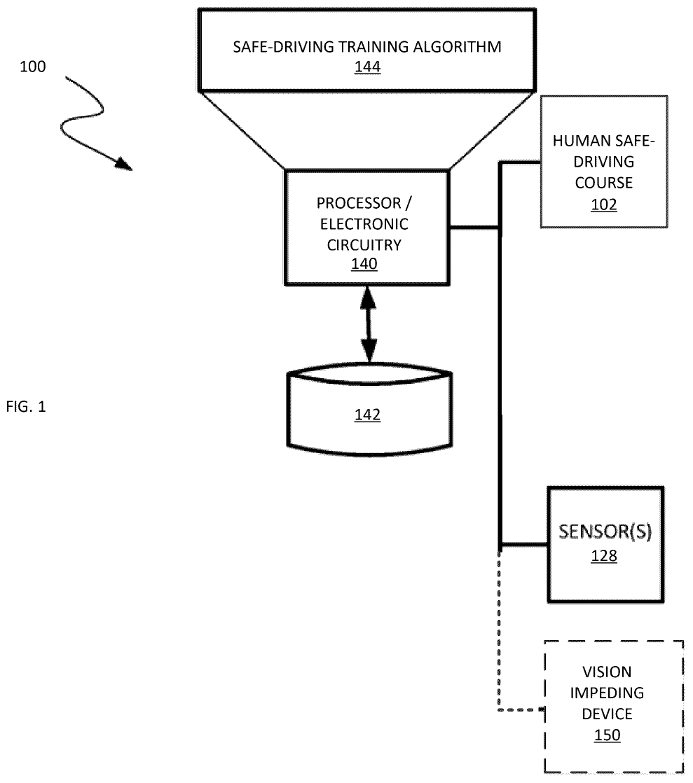

FIG. 1 is a schematic representing the mutual cooperation and exchange of data between or among some constituent components of the system 100 (structured according to the idea of the invention) during a given driving training session, when a human subject is engaged with a human safe-driving course 102. The programmable electronic circuitry or processor 140 in cooperation with the non-transitory tangible memory storage 142 are configured to run a safe-driving training algorithm 144 (implemented in a driving training program code that at least in part governs and appropriately modifies the operation of the course 102), to receive the output signals generated by the sensor(s) or sensor circuitry 128 (operably cooperated with certain constituent components of the course 102) as a result of tangible responses applied by the user of the course 102 to such constituent components), to process these signals to record and assess the indicia and/or data characterizing operation of the safe-driving course 102 and performance of the user (such as tangible response(s)) of the user during the driving training session to changes visually presented to the used by the human safe-driving course 102). The memory storage 142 can include, for example, random access memory (RAM), read-only memory (ROM), a hard drive, a solid-state drive, a USB flash drive, a memory card, an optical disc such as compact disc (CD) or digital versatile disc (DVD), a floppy disk, a magnetic tape, static random access memory (SRAM), dynamic random access memory (DRAM), magnetic random access memory (MRAM), a programmable read-only memory (PROM), an erasable programmable read-only memory (EPROM), an electrically erasable programmable read-only memory (EEPROM), or other known non-transitory, tangible memory storage.

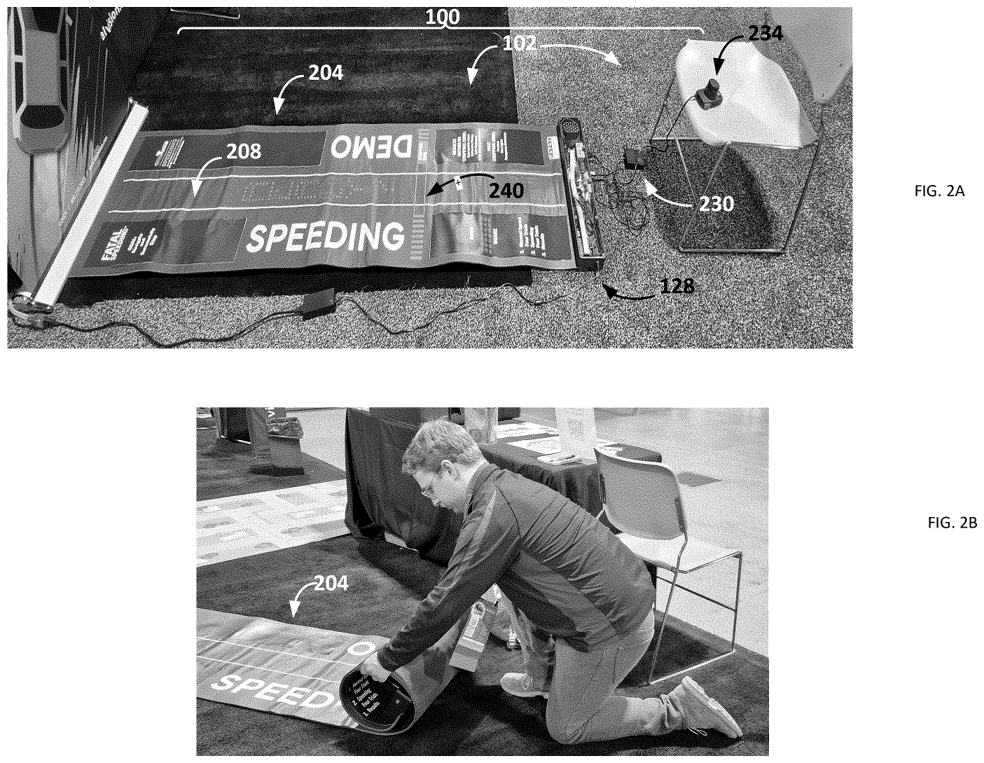

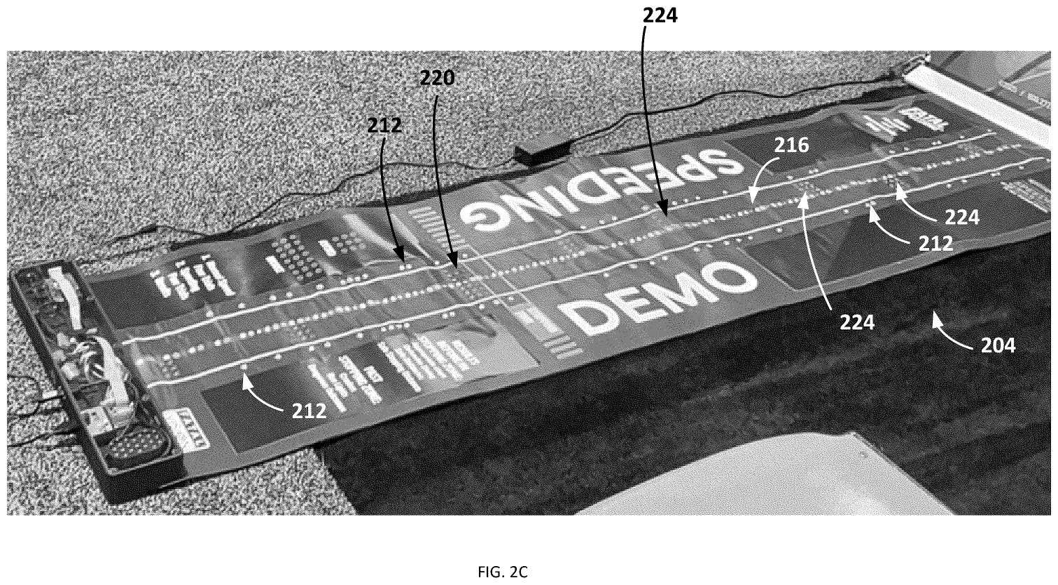

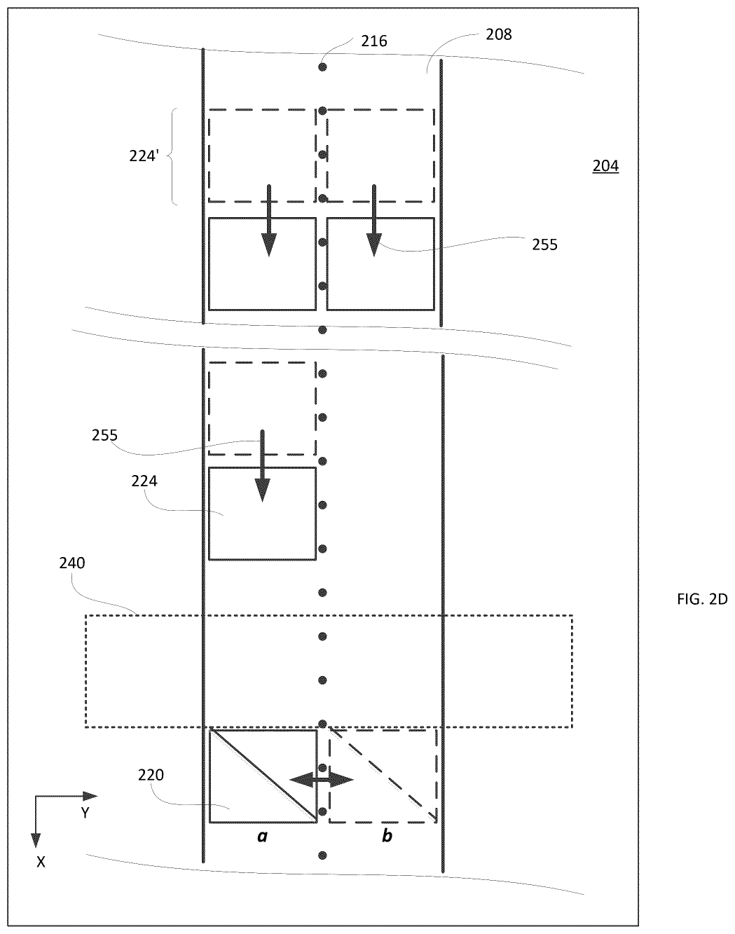

To put it all in perspective—and in reference to at least FIGS. 2A, 2B, 2C, and 2D—one practical embodiment 100 of the system, the human safe-driving course 102 of which includes an electronic device 204 containing a screen or substrate (shown here as a flexible mat—unfolded in FIG. 2A and being rolled in FIG. 2B) that carries (optionally permanent, visually stationary) indicia 208 representing a road and/or peripheral areas. The electronic device 204 additionally includes a multiplicity of lights or light sources such as LEDs spatially coordinated with the substrate. For example, such multiplicity of LEDs, organized as an overall two-dimensional array of LEDs, may be dimensioned and removably affixed to the substrate to cover or occupy the same area as that of the road marked at the substrate as well as the pre-determined area peripheral to that of the road.

Different portions of the overall multiplicity of light sources are operated independently from one another, with the use of a programmable processor 140, to dynamically change and vary—at least partly in response to the input provided by the user of the system, as discussed below—sub-areas of the electronic device that are “lit” (or “switched on”) to provide the user with representation of the operational status of the given driving training session that the use is engaged in. For example, as illustrated in FIG. 2A, at the beginning of the driving training session a portion of the overall multiplicity of lights is activated to indicate a notification “READY?” displayed along and within the bounds of the road (208). Similarly, a portion of the overall multiplicity of LEDs is operated to form at least a complementary visually-perceivable representation of the road (in the example of FIG. 2C—string(s) of lights 212 activated along the indicia 208 to complement the road boundaries and a string of lights 216 activated within the road boundaries to indicate a lane line), a visually-perceivable representation of a mock vehicle on the road (in the example of FIG. 2C—a two-dimensional array 220 of lights representing the user's or driver's mock vehicle or driver visual element or driver's proxy car), and visually-perceivable representation of road conditions (in the example of FIG. 2C—at least two-dimensional arrays 224 of lights that represent multiple obstacles on the road).

In operation, the obstacles on the road represent, for example, (i) other vehicles on either side of the lane line indicated with lights 216 that the user/driver has to avoid (in which case the corresponding arrays 224 are configured to produce an effect of being repositioned along the road (by activating and de-activating the LEDs with which the electronic device 204 is equipped) and/or (ii) road locations and/or areas identified as prohibited locations and/or areas (in which the corresponding pairs of arrays 224′ of lights are activated to show a blockage of the road, see FIG. 2D).

Optionally, yet another sub-set of the overall multiplicity of LEDs affixed to the substrate of the electronic device 204 may be dedicated to represent and display, in operation of the human safe-driving course 102, an unexpected traffic condition element (such as a pedestrian or an animal suddenly entering the road from the periphery) either at a first location outside of the road or at a second location on (within the bounds of) the road (not shown in FIGS. 2A through 2C). In this case, such sub-set (at least two individual LEDs) is operated to indicate (an optionally random in time) change of a position the unexpected traffic condition element between the first and second locations substantially independently from the tangible responses of the user.

As shown in the specific example of FIG. 2C, each of the arrays 220 and 224 of lights may be configured to form a substantially rectangular array of lights, but the color of light produced by the independently operated groups of LEDs (the array 220, the arrays 224, the string of lights 216, the light(s) representing the unexpected traffic a condition element, etc) may be chosen to be visibly different from one another.

An embodiment of the human safe-driving course may additionally include an optical filter layer—a physical layer of material carrying additional indicia (optionally, spatially reconfigurable, but in one implementation—a static marking) that represents at least one of a road sign and a regulatory sign and a target boundary—such as a target boundary 240 representing the ideal “stopping zone” with respect to which the user may cease the operation of the course 102 during a given driving training session by pressing the pedal 230. Such filter layer may be attached to and on top of the substrate prior to a given driving training session.

The example of the overall system human safe-driving course additionally includes a mock vehicle apparatus that is electrically connected with the corresponding sensors 128 of the system 100 and through the sensors—with the electronic device 204 and that contains at least a brake pedal 230 (operably configured, with the use of the appropriate program code, to slow or stop a rate of the change of the visually-perceivable representation of the road conditions in time during the driving training session, when the user operates the pedal 230) and a turn switch 234 configured to define such change at least in part.

### Optional Addition of a Vision-Impeding Device

Furthermore, in some driving training sessions the user's experience can be enhanced by the use of a cognition impairing apparatus 150 (such as a vision-impeding device; indicated in FIG. 1) worn by the user—for example, a pair of goggles containing specifically structured optical filters characterized by a pre-defined spectral pass band(s) and/or spatial structural patterns (disclosed, for example, in U.S. Pat. No. 10,366,630 or U.S. Pat. No. 12,094,357, the disclosure of each of which is incorporated by reference herein). Alternatively, such vision-impeding device may be configured as a pair of what can be referred to as occlusion glasses, in which at least some pre-determined portions of the optical filters are configured to be reversibly switchable between a clear state and an occluded state (disclosed, for example, in U.S. Pat. No. 12,156,741, the disclosure of which is incorporated by reference herein). Overall, such cognition impairing apparatus is judiciously structured to intermittently occlude vision of the human subject during at least one driving training session.

In particular, a given optical filter of the pair of vision-impeding goggles may be structured to possess a specifically defined optical filtering function with a spectral pass-band around a pre-determined wavelength and a specifically spatially oriented pattern in such filter's body defining different phase delays for different collimated beams incident onto a surface of such filter substantially normally (see, for example, a portion of the description in U.S. Pat. No. 12,094,357 related to FIG. 10), while the structure of the occlusion googles includes an overlay (affixed to at least a portion of the optical filter of such glasses) that includes a pattern at least partially obscuring a peripheral region of the optical filter and/or where such optical filter contains plurality of independently-controllable regions the opacity of which can be modified (as discussed in U.S. Pat. No. 12,156,741).

As a specific example—and in the case when the vision impeding device 150 is structured as a pair of occlusion glasses, the skilled artisan will readily appreciate that the program code implementing the safe-driving training algorithm 144 may be appropriately structured to additionally govern the operation of the occlusion glasses 150 (and, in particular, to switch the glasses between a clear state and an occluded state, and vice versa). In other embodiments, the occlusion glasses 150 may be already pre-configured to switch between the clear state and the occluded state, and vice versa, in accordance with a predetermined switching algorithm (program code; not shown), and therefore no intervention from the processor 140 may be required. Optionally, the occlusion glasses 150 may have a dedicated processor cooperated therewith or built therein that can be configured to cause the glasses to switch between the clear state and the occluded state with preselected intermittency of the occluded state.

In this specific example, the operable connection between the processor 140 of the system 100 and the occlusion glasses 150 can be a wired connection or a wireless connection. At least in one case, for example, the program code embodying the safe-driving training algorithm 140 is configured to activate the occlusion glasses 150 and control at least the timing, frequency, and/or duration of occlusion produced by these glasses—for example, based at least in part on the precision and timing with which the human subject performs the human safe-driving course 102. (In a related case, the process of processing the data may utilize other optional devices, such as, for example, a printer (not shown) and/or a display (not shown) utilized for printing and displaying the recorded data and/or performance assessments, respectively.)

As the human subject performs the safe-driving training course while wearing the occlusion glasses 150, the vision of the human subject is occluded at times (by having the human subject wear the glasses 150 that operate in the occluded state) while unoccluded at other times (by either placing the worn glasses 150 in the clear state or removing the glasses completely), respectively. The example of the occlusion glasses 150 is provided by the product distributed by Senaptec of Oregon, USA Such glasses are used in the embodiment of the invention to introduce transient visual perturbations while a participant perform the human safe-driving course. The glasses 150 are complemented with a judiciously configured program code governing a change of at least a pre-determined portion of a lens of the glasses 150 from clear state to opaque state, thereby restricting the participant's vision.

The comparison of first data representing the performance of the human subject and acquired during a first driving training session during which the vision of the human subject is not occluded with second data representing the performance and acquired during a second driving training session during which the vision of the human subject is at least partially occluded demonstrated that training a participant (the human subject) with at least brief occlusions of the vision leads to an increase in safety of driving as compared to training the participant with unperturbed vision, and that this effect can be retained for at least for a pre-determined time after the initial training.

Illustration of Variation of Road Conditions and/or Operation of the Human Safe-Driving Course.

The safe-driving algorithm 144 implemented in the driving training program code run by the processor 140 of the overall system 100 contains a program code to maintain the location of the array 220 of the lit LEDs along the road substantially unchanged while allowing for repositioning of the array 220 of the lit LEDs from one lane of the road 208 to another and back (across the lane line displayed by the lights 216), as will be discussed below—all as defined by the output signals produced by the sensor circuitry 128 in response to the user's operation of the turning switch 234 and the brake pedal 230. An example of specific modifications to the operation of the safe-driving course 102 is illustrated in FIG. 2D that schematically shows the essence of the driving training session. Here, during a given occurrence of the operation of the human safe-driving course 102, the processor 140 operates the overall multiplicity of LEDs to form multiple individual arrays 224 of lit LEDs in any of the lanes defined by the road boundary 208 and the string of LEDs 216 (here, only one such array 224 is shown in the left lane) that are propagated or moved or advanced (as shown with the arrow 255) along the axis x of the local coordinate system towards the array 220 representing the user's vehicle that may be positioned in any of the locations “a” in the left lane and “b” in the right lane. Together with the multiple individual arrays 224—and following such multiple arrays—the pair 224′ of arrays of lit LEDs (configured to indicate the blockage of the road 208) is propagated towards the array 220 substantially synchronously with the movement(s) of the array(s) 224. As the distance separating the array 220 (that remains at the same assigned x-coordinate) from the nearest array 224 is being reduced, the human subject of the driving training session (the user) operates the turning switch 234 to reposition the array 220 between the locations “a” and “b” at two different lanes, which represents a movement of the user's vehicle between the lanes to avoid a “collision” with the obstacle represented by the array 224. If the “collision” occurs (which will be displayed at the electronic device 204 via the overlap between the lit LED arrays 2020 and 224), such occurrence is accounted for as an error and the corresponding data (locations of the arrays, speed at which the arrays were propagated, timing parameters) are recorded for further analysis.

A given array 224 continues to propagate along the x-axis until the end of the road 208 pass the array 220, while the next in line array 224 is meanwhile advancing towards the x-coordinate at which the array 220 is positioned. In addition to the degree of freedom of repositioning the array 220 by turning the switch 234, the user has an option of stopping the driving session by pressing the pedal 230 (for example, when avoiding the collision is not possible otherwise). In this case, the processor 140 records multiple parameters such as the time of reaction of the user and the distance remaining between the arrays 224 and 220 along the x-axis, for example. Such stopping the driving training session understandably becomes a requirement when the blocking-the-road pair 224′ of the arrays is approaching the user's array 220. The reference moment of stopping the driving session may be defined, for example, by a moment when a given obstacle (the array 224 or the pair 224′ of arrays) is advanced into the area outlined by the target boundary 240—here, the remaining separation between the array 220 and the obstacle is minimal while there is no spatial overlap yet.

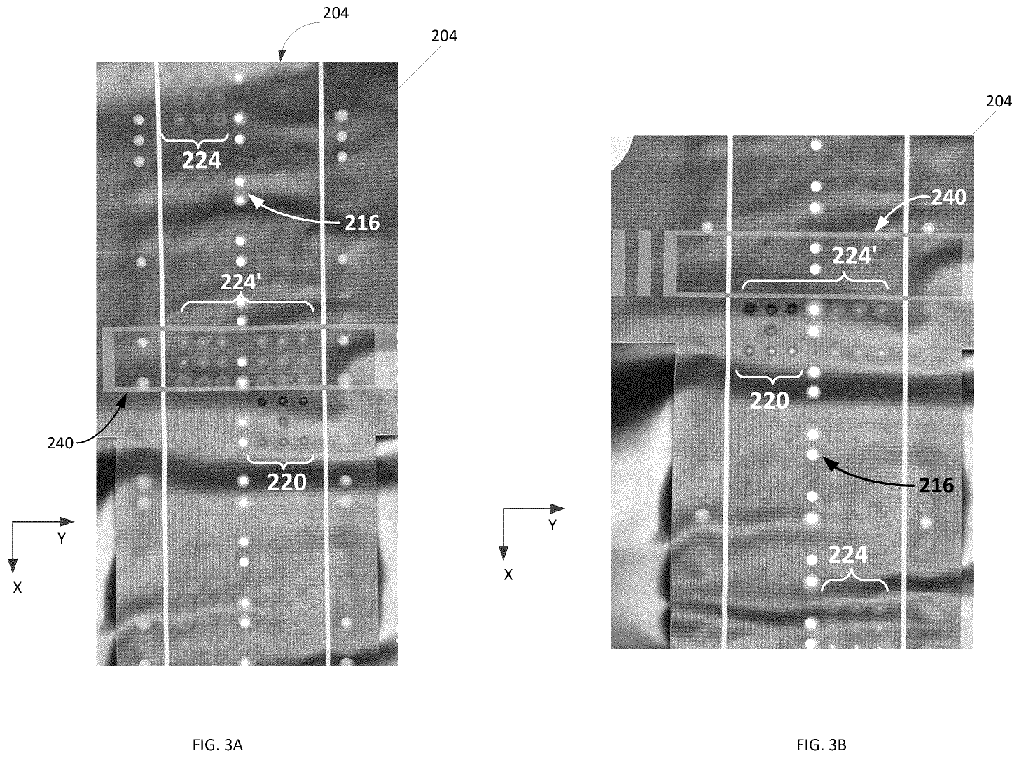

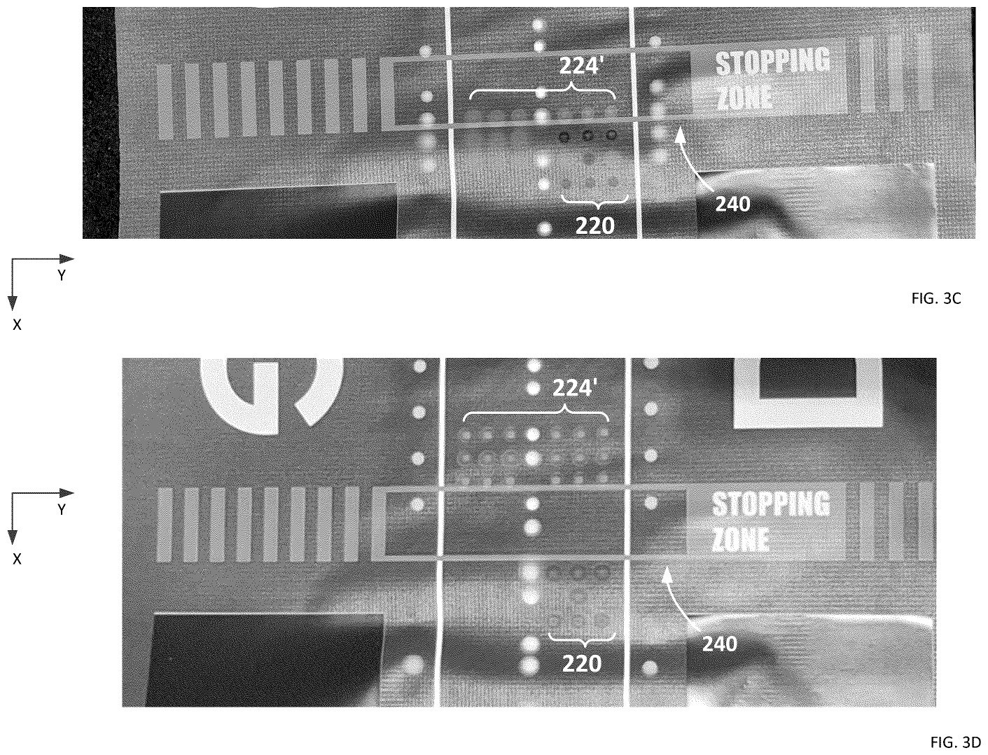

Such ideal or target moment of stopping the update in road conditions and, with it, stopping the driving training session is illustrated in FIG. 3A, where the impassable road obstacle represented by the pair 224′ of the LED arrays emitting light of the first color (for example, red) has been advanced by the operation of the course 102 along the x-axis (the length of the road 208) all the way into the target boundary 240. One possible error that the user can make during the driving training session—specifically, the stopping “too late” that resulted in a “collision” between the representation of the user's vehicle (LED array 220, emitting light of the second color, for example—blue) and the impassable obstacle—is illustrated in FIG. 3B, where the array 220 located in the left lane substantially fully overlaps with the left of the pair 224′ of the arrays representing such impassable obstacle. Here, the pair 224′ of the arrays of LEDs has been already advances beyond the target boundary 240.

FIG. 3C depicts the situation when the user—due to slow reaction and/or distraction during the driving training session (created, for example, by the use of a vision-impeding device)—pressed the brake pedal 230 too late, already after the advancing (towards the array 224 along the x-axis) pair 224′ of the arrays (of lit LEDs representing the impassable obstacle on the road) not only almost completely traversed the target “stopping zone” outlined by the boundary 240 but also at least partially occupied the location of the array 220. In practical terms, such occurrence corresponds to the “collision” as is recorded by the processor 140 as such.

FIG. 3D illustrates yet another situation when the user, while stopping the driving session correctly and without a collision between the obstacle (224′) and the user's vehicle (220) did so, nevertheless, too early—even before the pair of LED arrays 224′ entered the “stopping zone” outlined by the target boundary 240.

The skilled artisan now readily appreciates that, by changing the activation of the LEDs (forming at least the arrays 224, 224′) in time during a given driving training session (according to the program code representing safe-driving training algorithm), the electronic device 204 is governed to display a change of such visually-perceivable representation of road conditions in time—such as, for example, to represent an object moving, in relation to the road, towards the human subject (represented by the array 220).

In different driving training sessions, the corresponding speeds at which the changes of the visually-perceivable representation of the road conditions is carried out may be and preferably are different. For example, in a first driving session, the repositioning of the arrays 224 of lit LEDs along the road is carried out at a “normal” speed, practically sufficient for the user to operate the mock apparatus (230, 234) to react to such movement, while in a second driving training session the speed is substantially increased (thereby mimicking a high-speed driving of the user).

### Assessment of Performance During the Safe-Driving Course.

An implementation of the idea of the invention is configured to collect data that allows the user, at the end of at least two driving training sessions, to interpret a visual readout that shows where and how late or on-time the user applied the brake pedal 230.

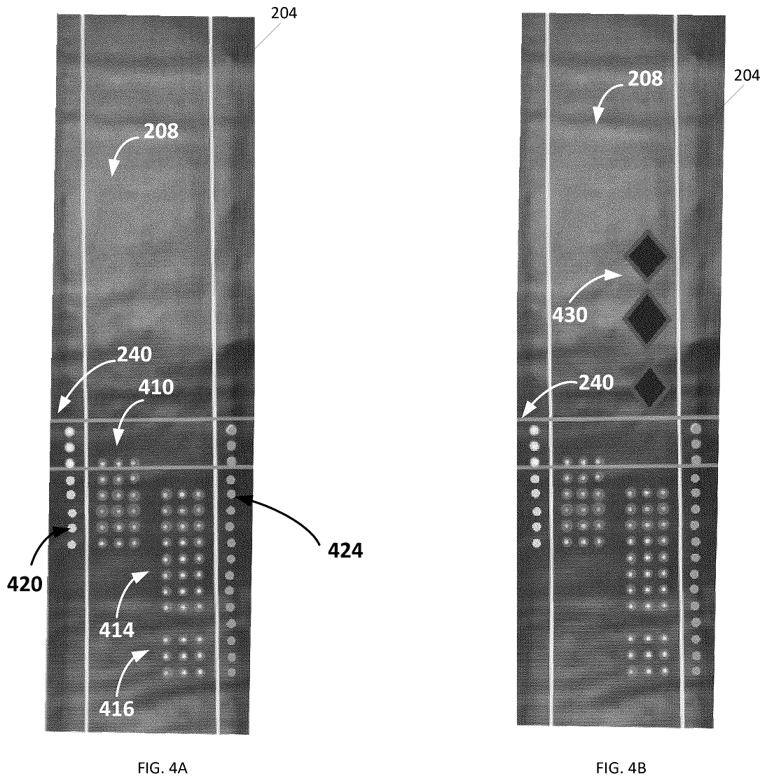

FIGS. 4A and 4B schematically illustrate the display of results, summarizing the performance of the human subject (the user) who has accomplished at least two driving training sessions (one at a normal speed, another—at a high, accelerated speed) of the course 102. Notably, according to the idea of the invention, the results are necessarily presented at the same electronic device 104 that has been used for the driving training exercise(s)—and are displayed by forming judiciously defined arrays of lit LEDs.

The rectangular arrays of lights 410, 414, 416 show the location (along the road 208) occupied by the corresponding road obstacle (224 or 224′) when the human user stopped the proxy car 220, over two driving training sessions each containing an adjustable number of trials.

For one specific example of a driving training session performed at a “normal speed, the results are presented on the left-hand side of the road 208, with a single rectangular array 410 of 3×6 light that extends 5 lights past (below) the designated target boundary 240 (the stopping zone), which indicates that the human user erroneously allowed the obstacle to move the corresponding distance (stopped the proxy car 220 too late) in one or more of the trials. The (upper) singular row of lights of the array 410 that remains still in the stopping area bound by the boundary 240 indicates this user allowed the obstacle to move a corresponding extra distance (stopped the driving session too late) in one or more of the trials. The result shows that within the four trials, the proxy stopped between two to five increments of distance too late: due to the time delay, incorporated into the appropriate program code, the road conditions are intentionally not modified right away when the human user engages the brake 230, to resemble and mimic the actual behavior of the car on the real road. The top result is at a speed that produces a proxy car length of stopping distance of where the proxy was when the brake engaged and where the proxy ends up.

For another specific example of a driving training session performed at an “exceedingly high speed, the results are presented on the right-hand side of the road 208, with the use of rectangular arrays 414, 416 of lit LEDs separated from one another by a one distance increment while the 3×8 array 414 is separated from the lower portion of the target boundary 240 (target stopping zone) by one distance increment and from the following 3×3 array 416—by one distance increment. These correspond to and represent the stopping locations of the obstacles when the course 102 was navigated at an increased speed. It can be observed—in comparison with the results expressed by the array 410—that the increased speed during the driving training session also increases the distance traveled between a moment when the human user engages the brake 230 and when traffic is stopped. At this speed it is an increase of nine pixels (or three car proxy lengths, using the dimensions of the array 220 discussed above). This result shows the time delay in stopping the movement corresponds resulted in the extra distance travelled between four and fourteen distance increments. The earliest braking was delayed (as compared with the appropriate one) such that the extra distance travelled corresponded to four distance increments, while the largest delay in applying the breaks 230 results in a much longer extra distance traveled—fourteen distance increments.

The length of the strings 420, 424 of auxiliary lights (which in practice emit light with the color different from that of light by the arrays 410, 414, 416) represents the length of the stopping results a human-user has in both the first and second set of the two trials of the same driving training session. The color of the light emitted by the strings 420, 424 may be varied depending on which trial it is outlining, the slower/non-speeding trials or the too fast/speeding trials.

At least in one specific implementation of the invention, the results of the driving sessions signify when the human user engages the brake pedal peripheral in response to the additional brake stimulus (visual prompt) in the activity and what speed the car proxy is set to. The brake stimulus is a dedicated indicium (now shown in the Figures for simplicity of illustrations)—that appears at a random time during the trial at a fixed distance from the car proxy 220. When this indicium appears, the user must be able to identify when it appears and react in time to stop the movement before the indicium reaches the array 220. The human user must also consider the braking distance (an additionally calculated number of the distance increments the obstacle will move depending on the traffic speed used in a given driving training session).

Optionally, the results of the exercise displayed at the electronic device 204 may show the number of collisions a human user caused in the trials—for example, by highlighting corresponding portion(s) of the overall multiplicity of LEDs with which the device 204 is equipped in the form of polygons such as, for example, diamond-shaped arrays 430 (see FIG. 4B).

The evaluation of the indicia representing the results of navigating the human safe-driving course may be evaluated as follows:
The length of time associated with and the location of the event represent whether a user was able to safely navigate the road, identify when the user needed to stop, and if the user was able to stop safely or in time to avoid hitting the stop stimulus (224′).
The farther a result is from the stopping zone (boundary 240), the slower the human user was to identify the obstacle and stop.
Results showing a user was unable to stop in time or safely will lead to discussions about: How speeding leads to longer stopping distances; How speeding leads to more impactful crashes; How using the vision-impeding devices can impact a user's ability to identify obstacles in the road or react in time and or drive to begin with; How speeding leads to less time to react to obstacles/other people on the road; and How speeding reduces a person's ability to scan the road, their peripheral vision shrinks.

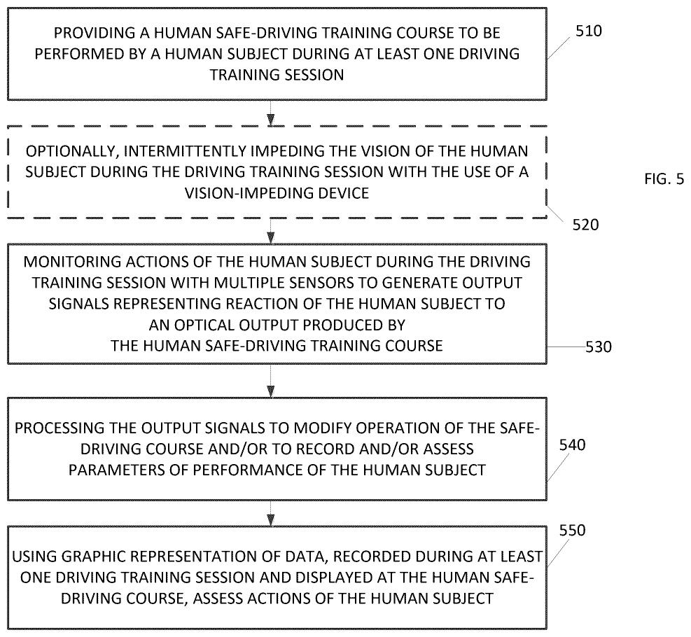

FIG. 5 is a flow diagram schematically depicting an embodiment of the method carried out by the system 100. Here, at 510, a human subject is engaged in performing a safe-driving training course during a driving training session (while optionally wearing a vision-impeding device) Block 520 represents a step of intermittently occluding the vision of the human subject during the driving training session (in case the occlusion glasses are being used) between a clear state in which the vision of the human subject is unoccluded and an occluded state in which the vision of the human subject is at least partially occluded, and/or vice versa.

At 530, the process of monitoring the performance of the human subject during the driving training session with one or more employed sensors 128 to generate output signal and/or indicia representing the tangible and measurable parameters of the performance by the human subject during the driving training session. This step can also be performed manually (instead of automatically, that is, instead of utilizing the processor 140) based on the signals output by the sensor(s).

Block 540 represents effectuating of the safe-driving training algorithm 144 by the processor 140 to record the output signals received from the sensors 128 and/or various parameters (such as timing and/or timing sequence of events, assess the safe-driving training performance of the human subject. In some embodiments, the driving training performance of the human subject may be recorded for assessment at a later time. In another case, the safe-driving training performance is recorded in the current driving training session and assessed it comparing the tangible results to results of the safe-driving training performance recorded in a previous driving training session. Another type of assessment can be provided, for example, by comparing the recorded driving training performance for the current driving training session with the recorded pre-test performance from the pre-test that was performed earlier that day or another day.

Finally, at 550, the data characterizing the operation of the human safe-driving course 102 and collected by the system 100 is presented at the electronic device 204 with the use of reconfigurable arrays of LEDs and assessed by the user with or without the help of the curator.

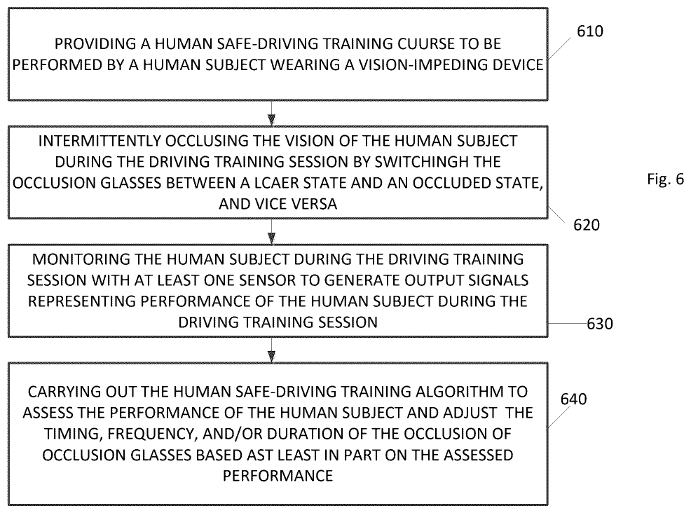

FIG. 6 is a flow diagram of the method performed by the data processing unit with the use of the algorithm 140 in accordance with another related embodiment. Blocks 610, 620, 630 of FIG. 6, in the shown example, represent substantially the same method steps as those of blocks 510, 520, 530 of FIG. 5. According to the idea of the invention presented here, the safe-driving training algorithm 144 is used to control the operation of the vision-impeding device 150 when such a device includes reconfigurable occlusion glasses—as shown at 640—to adjust the timing, frequency and/or duration of the occlusions, i.e., the switching between the clear state and the occluded state, based at least in part on the assessed balance training performance. Here, the program code embodying the self-driving training algorithm 144 is used to processes the output signals generated by the sensor(s) 128 and to control the timing, frequency and/or duration of the occlusions of the glasses 150 based at least in part on the output signals of the sensor(s) 128. For example, assuming the driving performance indicator used to assess performance is the time of reaction, of the human subject, to the running light of the string of lights that moves along the road displayed on the electronic device of the human safe-driving course at the periphery of the field-of-view of the human subject, the algorithm 144 could be configured to occlude at least a portion of a periphery of a lens of the pair of occlusion glasses 150 with a pre-determined frequency and/or with a pre-determined duty cycle and/or reduce the timing, frequency and/or duration of such occlusion if the reaction time remains still longer that a predetermined threshold value representing statistically-significant reaction time based on the acquired data. As with the embodiment represented by the flow diagram of FIG. 5, other balance performance indicators can be used to assess the overall performance of the human subject.

Overall, upon completion of the driving training sessions, the participant (the human subject) is shown multiple results that include—but are not limited to:
Locations of stopping the driving session and distances between such locations. (If the indicia is placed ahead of or in the stopping zone, the human subject was able to successfully navigate the course and its trials. If the Indicia is placed behind the stopping zone and/or overlapping the proxy car, the human subject failed to brake in time. These data are then discussed in context of real-world driving outcomes like defensive driving, crashes, fatalities, and other driving incidents/concepts.
The number of times the piloted proxy car clipped/overlapped with an obstacle before the braking obstacle.
The difference between the subject's normal session stopping distance and speeding stopping distance.

While not necessarily indicated in Figures, the use of an embodiment structured according to the idea of the invention may be governed by a processor controlled by instructions stored in a memory (for example, when the embodiment including multiple optical fiber components is operated in conjunction with an optical detector system the constituent optical detector components of which are positioned to receive light from corresponding outputs of the multiple optical fiber components. The memory may be random access memory (RAM), read-only memory (ROM), flash memory or any other memory, or combination thereof, suitable for storing control software or other instructions and data. Those skilled in the art should also readily appreciate that instructions or programs defining the functions of the present invention may be delivered to a processor in many forms, including, but not limited to, information permanently stored on non-writable storage media (e.g. read-only memory devices within a computer, such as ROM, or devices readable by a computer I/O attachment, such as CD-ROM or DVD disks), information alterably stored on writable storage media (e.g. floppy disks, removable flash memory and hard drives) or information conveyed to a computer through communication media, including wired or wireless computer networks. In addition, while the invention may be embodied in software, the functions necessary to implement the invention may optionally or alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

Understandably, a computer program product containing program code(s) embodying and/or governing the operation of at least one implementation of the idea of the invention remain within the scope of the invention—and, in particular, the embodiment of a computer program product for operating a system including a human safe-driving course with the purpose of determining a change in time of reaction of a human subject engaging with such human safe-driving course. Such computer program product may, in one implementation, include a computer usable medium having computer readable program code thereon. The computer readable program code may include code for processing output signals, generated by first and second sensors that are configured to detect inputs applied to a brake pedal and a turn switch of a human safe-driving course by the human subject during at least one driving training session, to record first data representing tangible responses of the human subject to changes in the human safe-driving course during the at least one driving training session; code for modifying an operation of the human safe-driving course in response to said output signals; and code for recording second data representing the operation of the human safe-driving course in correspondence to the output signals. Alternatively or in addition, the computer readable program code may include at least one of the following: code for altering visual elements of the human safe-driving course during the at last one driving training session; code for introducing optical noise at a pre-determined first location of the human-safe-driving course (here, such noise is visual and implemented by switching on and off the LEDs around the pre-determined first location to impede visual identification of a visual element of the visual elements of the human safe-driving course at the predetermined first location); code for repositioning a driver visual element of the human safe-driving course that is representing the human subject, in response to said inputs, to avoid a spatial overlap between the driver visual element and at least one other visual element of said course at the electronic device of the human safe-driving course; code for ceasing the process of modifying the operation of the human safe-driving course and stopping the at least one driving training session when the processor determines that the spatial overlap has occurred and for identifying the spatial overlap as a road collision; and code for delaying, in a pre-determined fashion, at least one of the altering and repositioning with respect to an input of the inputs. Optionally, substantially every implementation of the computer program product may include code for visually presenting a spatially-repositionable traffic condition element either at a first location outside of a road displayed at an electronic device of the human safe-driving course or at a second location on said road and changing a position of said traffic condition element between the first and second locations substantially independently from the inputs.

For the purposes of this disclosure and the appended claims, the use of the terms “substantially”, “approximately”, “about” and similar terms in reference to a descriptor of a value, element, property or characteristic at hand is intended to emphasize that the value, element, property, or characteristic referred to, while not necessarily being exactly as stated, would nevertheless be considered, for practical purposes, as stated by a person of skill in the art. These terms, as applied to a specified characteristic or quality descriptor means “mostly”, “mainly”, “considerably”, “by and large”, “essentially”, “to great or significant extent”, “largely but not necessarily wholly the same” such as to reasonably denote language of approximation and describe the specified characteristic or descriptor so that its scope would be understood by a person of ordinary skill in the art. In one specific case, the terms “approximately”, “substantially”, and “about”, when used in reference to a numerical value, represent a range of plus or minus 20% with respect to the specified value, more preferably plus or minus 10%, even more preferably plus or minus 5%, most preferably plus or minus 2% with respect to the specified value. As a non-limiting example, two values being “substantially equal” to one another implies that the difference between the two values may be within the range of +/−20% of the value itself, preferably within the +/−10% range of the value itself, more preferably within the range of +/−5% of the value itself, and even more preferably within the range of +/−2% or less of the value itself.

The use of these terms in describing a chosen characteristic or concept neither implies nor provides any basis for indefiniteness and for adding a numerical limitation to the specified characteristic or descriptor. As understood by a skilled artisan, the practical deviation of the exact value or characteristic of such value, element, or property from that stated falls and may vary within a numerical range defined by an experimental measurement error that is typical when using a measurement method accepted in the art for such purposes. Other specific examples of the meaning of the terms “substantially”, “about”, and/or “approximately” as applied to different practical situations may have been provided elsewhere in this disclosure.

References throughout this specification to “one embodiment,” “an embodiment,” “a related embodiment,” or similar language mean that a particular feature, structure, or characteristic described in connection with the referred to “embodiment” is included in at least one embodiment of the present invention. Thus, appearances of the phrases “in one embodiment,” “in an embodiment,” and similar language throughout this specification may, but do not necessarily, all refer to the same embodiment. It is to be understood that no portion of disclosure, taken on its own and in possible connection with a figure, is intended to provide a complete description of all features of the invention.

For the purposes of this disclosure and the appended claims, the expression of the type “element A and/or element B” is defined to have the meaning that is equivalent to that of the expression “at least one of element A and element B”.

The disclosure of each reference and/or patent document cited herein is incorporated herein by reference.

While the invention is described through the above-described specific non-limiting embodiments, it will be understood by those of ordinary skill in the art that modifications to, and variations of, the illustrated embodiments may be made without departing from the inventive concepts disclosed herein. The disclosed aspects may be combined in ways not listed above. Accordingly, the invention should not be viewed as being limited to the disclosed embodiment(s).

1. A system for training safe driving by a human subject, the system comprising:
a human safe-driving course to be performed by the human subject during at least one driving training session;
first and second sensors configured to detect inputs applied to said course by the human subject during the at least one driving training session and to generate output signals representing said inputs; and
a processor operably coupled with a tangible non-transitory memory storage and configured at least to execute a driving training program code stored in said storage, the driving training program code including:
code for processing the output signals to record first data representing tangible responses of the human subject to changes in the human safe-driving course during the at least one driving training session,
code for modifying operation of the human safe-driving course in response to said output signals, and
code for recording second data representing the operation of the human safe-driving course in correspondence to the output signals.

2. A system according to claim 1, configured to generate tangible indicia of operation of the human safe-driving course modified in response to said output signals.

3. A system according to claim 2, wherein the driving training program code is configured to vary one or more of timing, frequency, spatial distribution, and duration of presentation to the user of reconfigurable visual indicia of operation of the human safe-driving course.

4. A system according to claim 1, wherein the human safe-driving course includes:
an electronic device configured to present visually course data that includes the first data, said electronic device including a plurality of independently operable source of light forming at least a first visually-perceivable representation of a road, a second visually-perceivable representation of a mock vehicle on the road, and a change of a third visually-perceivable representation of road conditions in time; and
a mock vehicle apparatus operably connected with the electronic device and containing at least a brake pedal configured to slow or stop a rate of the change and a turn switch configured to define said change at least in part.

5. A system according to claim 4, wherein said road conditions include at least one of:
(5A) a position and/or orientation of the mock vehicle on the road;
(5B) a position and/or orientation of at least one obstacle on the road, said at least one obstacle representing road locations and/or areas identified as prohibited locations and/or areas on the road.

6. A system according to claim 1, comprising a first constituent apparatus of the human safe-driving course that is configured to visually present said tangible responses and that includes a flexible mat cooperated with an array of light-emitting diodes controlled by said processor.

7. A system according to claim 6, wherein said flexible mat including an optical filter layer containing a spatially reconfigurable indicia representing at least one of a road sign and a regulatory sign.

8. A system according to claim 1, comprising a source of audible sound configured to be activated at least when a tangible response of the human subject to said changes causes an outcome interpreted by the processor as a road collision.

9. A system according to claim 1, wherein the driving training program code includes:
(9A) code for altering visual elements of the human safe-driving course during the at last one driving training session, and/or
(9B) code for introducing optical noise at a pre-determined first location of the human-safe-driving course, said noise impeding visual identification of a visual element of the visual elements of the human safe-driving course when such visual element is at the predetermined first location;
(9C) code for repositioning a driver visual element of the human safe-driving course that is representing the human subject, in response to an input applied by the human subject to a device of said course, to avoid a spatial overlap between the driver visual element and at least one other visual element of said course; and/or
(9D) code for ceasing said changes in the human safe-driving course and stopping the at least one driving training session when the processor determines that said spatial overlap has occurred and for identifying said spatial overlap as a road collision; and/or
(9E) code for delaying, in a pre-determined fashion, at least one of said altering and repositioning with respect to a tangible response of said tangible responses.

10. A system according to claim 1, wherein the code for modifying operation of the human safe-driving course includes code for visually presenting a spatially-repositionable traffic condition element either at a first location outside of a road displayed at an electronic device of the human safe-driving course or at a second location on said road and changing a position of said traffic condition element between the first and second locations substantially independently from said tangible responses.

11. A system according to claim 1, wherein the at least one driving training session includes first and second driving training sessions, and wherein the driving training program code is configured to compare first and second data acquired during the first driving training session with corresponding first and second data acquired during the second driving training session and to generate indicia of a change of said performing between the first driving training session and the second driving training session.

12. A method comprising:
with the use of the system according to claim 1:
during a first driving training session and with the use of a processor, executing program code to introduce changes in the human safe-driving course by varying first visually-perceivable indicia in a first fashion, wherein said first visually-perceivable indicia represent at least a road and/or change in road conditions in time and are generated by a constituent device of the human safe-driving course and;
with the first and second sensors, generating first output signals representing tangible responses of the human subject to said changes;
repositioning second visually-perceivable indicia representing the human subject across a surface of the constituent device in response to said first output signals, and
recording first output data representing the tangible responses and second output data representing operation of the human safe-driving course in correspondence to the first output signals during the first driving training session.

13. A method according to claim 12, wherein said varying the first visually-perceivable indicia in the first fashion driving includes varying one or more of speed, frequency, spatial distribution, and duration of presentation to the user of said first visually-perceivable indicia.

14. A method according to claim 12, further comprising:
ceasing the first driving session either substantially at a moment of time when second output data satisfy a first pre-determined condition representing a road collision or upon a first pre-defined time duration having lapsed.

15. A method according to claim 12, further comprising:
during a second driving training session and with the use of the processor, executing program code to introduce said changes in the human safe-driving course by varying first visually-perceivable indicia in a second fashion;
with the first and second sensors, generating second output signals representing tangible responses of the human subject to said changes;
repositioning second visually-perceivable indicia representing the human subject across the surface of the constituent device in response to said second output signals, and
recording third output data representing the tangible responses and fourth output data representing operation of the human safe-driving course in correspondence to the second output signals during the second driving training session.

16. A method according to claim 15, further comprising:
ceasing the second driving session either substantially at a moment of time when the fourth output data satisfy a second pre-determined condition representing a road collision or upon a second pre-defined time duration having lapsed.

17. A method according to claim 15, wherein said varying the first visually-perceivable indicia in the second fashion driving includes varying one or more of speed, frequency, spatial distribution, and duration of presentation to the user of said first visually-perceivable indicia.

18. A method according to claim 12, wherein at least one of said varying and repositioning includes turning on and/or on sources of light at the constituent device substantially at said first rate.

19. A method according to claim 12, wherein the human subject wears a device configured to impede vision of the human subject when placed in a line of sight of the human subject.

20. A method according to claim 19, wherein, when the device configured to impede vision of the human subject includes a pair of occlusion glasses to be worn by the human subject during the at least one driving training session, intermittently occluding said vision of the human subject by switching the pair of occlusion glasses between a clear state in which the vision is not occluded and an occluded state in which the vision is occluded and vice versa during a corresponding driving training session. said at least one driving trainings session.
